(19) United States
(12) Patent Application Publication
(10) Pub. No.: US 2002/0146309 A1
(43) Pub. Date: Oct. 10, 2002

(54) Method and apparatus for the transfer of supports of electronic and/or computer components in the form of disks

(75) Inventor: Robert Di Cesare, Clapiers (FR)

Correspondence Address: YOUNG & THOMPSON, 745 SOUTH 23RD STREET 2ND FLOOR, ARLINGTON, VA, 22202

(73) Assignee: R2D INGENIERIE S.A.

(21) Appl. No.: 09/904,104

(22) Filed: Jul. 13, 2001

(30) Foreign Application Priority Data
Apr. 6, 2001 (FR) 01.05067

(51) Int. Cl. B65G 49/07

(52) U.S. Cl. 414/416.08

(57) ABSTRACT

The invention concerns a method and an apparatus for the transfer of supports (2) of electronic and/or computer components in the form of disks.

This method consists of:

1) grasping and removing from a supply basket (4) the supports (2) in staged superposition using a first support transfer manipulator (8) with planar movement, and moving this manipulator (8) to insert the supports (2) inside a cage (12) of a second support (2) transfer manipulator (10) while turning them over.

2) turning the cage (12) over between two concurrent orientations by tipping it around a pivot axis (A2) materialized (32) at its base and through which it is supported.

3) Grasping the supports (2) in braced juxtaposition and taking them out of the cage (12) up to the unloading station using an unloading device (30) of a third manipulator which runs inside a passageway made through the cage (12).

### BACKGROUND OF THE INVENTION

1. Field of the Invention

The invention concerns the field of flat electronic and/or computer component handling during manufacturing. Such components are for example supports made out of semi-conductor materials in the form of disks that are handled in stacked packs. The invention concerns more specifically a method to turn over such supports in packs between two concurrent orthogonal planes, from a supply station to an unloading station. The invention also concerns an apparatus that contains the means of implementation of this method, and especially cooperating devices or manipulators allowing for the turn-over of said supports.

2. Description of Related Art

It is frequent during the manufacturing of electronic and/or computer components including a support in the form of a disk that it is necessary to move or change the position, or orientation of such supports from one processing station to another. These operations are commonly performed in an automated manner by manipulators at a transfer station placed between both processing stations. The supports are arranged in tiered superposition at the exit of the first processing station inside a basket located at a supply station of the transfer station. The supports are then moved from this transfer station to an unloading station where they are retrieved at the entrance of another processing station.

Under a first type of manipulator designed to transfer in packs supports along their general plane, said supports are grasped individually and moved together in space in a planar manner. For that purpose, a manipulator is used that has several gripping devices such as arms assigned to a respective support to be individually grasped. Such gripping devices are braced by being arranged on the manipulator in tiered superposition matching the arrangement of the supports inside the supply basket and can be moved jointly in a planar manner in various space directions. The supports are commonly grasped at their periphery or by being simply supported, as the gripping devices are each made of grasping devices arranged in the same overall plane at a distance from one another. For example, in the case of arms, they each have a pair of branches.

Reference can be made to patent FR2778496 (RECIF) that describes such a manipulator of the support planar transfer type. Under that prior art, it is more specifically proposed to equip a manipulator with specific means to track the initial angular position of the supports and with means to rotate them on each other. The result is that the support transfer is made not only in a Cartesian manner along the three space dimensions, but also with a change of angular orientation of the supports in their overall plane.

This type of manipulator is commonly used to transfer supports from one basket or equivalent to another. The solutions proposed for the mobility of the gripping devices, both in the various maneuver steps and in the structure of the means and paths of transfer, tend inopportunely to hinder production rates. Another problem posed by this type of manipulators lies in the pollution risk for the supports during their transfer, especially because of the presence of the moving and guiding means of the gripping devices.

Under a second type of manipulator designed to turn over in packs supports along two concurrent—more specifically orthogonal—planes, said supports are placed inside a container that can be turned over. This container, which is for example given the form of a basket similar to the supply basket, has several devices respectively gripping the supports at their periphery in tiered superposition and a window to insert and remove the supports.

Reference can be made for example to U.S. Pat. No. 6,152,680 (HOWELLS) that describes such manipulator of the support turn-over type. Under this prior art, the turn-over container is housed in a removable manner inside a caisson provided with a frame. This frame carries the container in a removable manner and can turn over. The container loaded with supports is introduced into the caisson, then turned over by turning over the frame, then taken out of the caisson. The supports are thus turned over in packs from the supply orientation to the unloading orientation concurrent with the former.

The uniqueness of this prior art mentioned as example resides especially in the layout of the container turn-over means that are of the type with rollers on the frame that run along guide slides arranged at right angles on the caisson.

Such manipulator has the disadvantage of using elements (caisson—frame—container) that are contained successively into one another. Such an arrangement makes the structure of the manipulator complex and clutters the environment close to the supports. Here again, it results into a hindrance of the transfer rates achieved and into an increase of the support pollution risk. In addition, the specific means with rollers used to turn over the container tend themselves to hinder the production rates and require ill-timed regular maintenance.

### BRIEF SUMMARY OF THE INVENTION

The invention in its generality aims at proposing a method to transfer supports from a supply station to an unloading station that includes turning over said supports. Correlatively, the invention proposes an apparatus consisting of several cooperating devices or manipulators to implement this method. It is to be understood that the invention also concerns the individual structure of each of these devices or manipulators that make up the apparatus.

More specifically, the purpose of the method under the invention is to increase the support transfer rates while protecting them as much as possible against pollution hazards. The purpose of the invention is also to arrange the supports at the unloading station so that they more easily accessible without thereby causing an unwanted reduction of the transfer rate.

This invention will be described in its overall character by developing the various operations under the proposed invention that are successively carried out, with the special steps pertaining to each one, and by describing the various manipulators used to perform those operations. It is to be understood that this overall description covers the various characteristics and uniqueness of the invention, taken in combination.

In a first major operation for support transfer, a first manipulator of the support planar displacement type is used to grasp said supports and remove them individually from a basket at the supply station. After they are removed, the supports are led to a second transfer manipulator turning over the supports between two concurrent planes where the supports are set down.

It is to be reminded that the manipulator of the first type has individual support gripping devices, such as arms given each the form of a pair of branches, and means to maneuver jointly these gripping devices for planar displacement in packs of the supports along both directions of at least one transfer plane. The gripping devices of this manipulator are preferably supported by a column with its front face itself supported by means for its planar movement along both directions of at least one plane. It is to be noted that accessorily and especially to grasp the supports, the support gripping devices move in a planar manner along a plane concurrent with the former.

Under a clever choice proposed by the invention, the means to move the column are arranged in tiered arms successively hinged to one another that support the column in a rotating manner. It shall be noted that under the various options, the supports move along said plane concurrent with the former, either preferably through mobile assembly of the gripping devices on the column, or through vertically mobile assembly of the column itself on the respective arm.

This arrangement of the manipulator of the first type is preferred because of the gain achieved in the transfer rates and reduced space requirement of the related station. In addition, the column displacement is achieved through driving and guiding means that may be contained inside the arms or be away from the close vicinity of the supports so as to protect them against any pollution from the moving and guiding means of the manipulator.

It is to be noted at this stage of the description that the rotation on itself of the column on the first manipulator makes it possible to place the second manipulator close to the first one to reduce its travel with consequences that are themselves favorable for the production rates achieved. It is also to be noted that such proximity does not hinder the alternating use of several supply baskets arranged side by side at the entrance of the transfer station while keeping the above-mentioned advantage of the limited travel of the first manipulator to the second.

In a second major operation of support transfer, said supports are turned over along planes concurrent with the means of the second operator. Under an important aspect of the invention, this second manipulator is arranged so as to allow for its being run through by an unloading device, part of a third manipulator, that is implemented during a third major operation of the method under the invention. The above-mentioned arrangement of the second manipulator is more specifically such that the second major operation under the invention consists of turning the supports over in packs wile holding them individually inside a container that allows for its being run through from one edge to the other by an unloading device that grasps individually and removes in packs the supports.

It is to be reminded that the second manipulator has a receiving and transfer container to turn over the supports and maneuvering means to turn over this container between two concurrent planes. This container is equipped with individual gripping devices for the supports in tiered superposition and has a first access window to its inside volume for at least inserting, or also removing the supports.

To implement the second operation of the method under the invention, this manipulator has a characteristic under which the receiving and turn-over container is given the form of a cage. This cage shall be made so that it has at least a second window associated with another opposite window for running through the cage an unloading device for the supports that it grasps and takes outside and beyond said cage while running through it.

It is to be noted that under the various options proposed based on the orientation of the support unloading in relation to their initial insertion orientation, the other above-mentioned opposite window is either a third window, or preferably the first insertion window. A subsidiary advantage resulting from the cage shape of the container should now be stressed, that lies in the capability to change the angular orientation on themselves of the supports in relation to the orientation difference between the first insertion window and the third support removal window. It should be noted that this angular orientation change of the supports is achieved without cluttering the close proximity of said supports by specific means.

It should also be understood that the unloading device can be a gripping device of another manipulator with planar displacement of the first type previously used, but that under another aspect of the invention, said device is preferably part of a manipulator of the third type to be described further below.

The cage is mounted so that it pivots at its base on a guide shaft that tips it. This tipping is caused by maneuvering means on the second manipulator that are favorably arranged coaxially to the guide shaft. It should be stressed that the cage shape of the second manipulator and its tipping at the base permit to free the close vicinity of the supports that it contains so as to protect them against pollution hazards and to provide free and individual access to said supports for the unloading device.

To protect the supports against any alteration, or even degradation, when tipping the cage, said cage is preferably equipped with hold-down means for the supports inserted. These means consist of support locking devices that can move between two positions of support release and holddown respectively. It should be understood that theses means are maneuvered during specific steps of the second support transfer operation that take place before and after the turning over by tipping the cage.

It should be noted that the cage shape of the second manipulator proposed by the invention, in combination with the support hold-down means with which it is equipped, offers the possibility of an additional function for this manipulator. Indeed, since the tipping of the cage around the associated shaft can be achieved with any angular displacement, the second manipulator can be used for turning over the supports from one face to the other, with a tipping of the cage by an angle of approx. 180°.

Under a preferred embodiment of the locking devices that are part of the support hold-down means, said devices are shaped as rods provided with support individual gripping devices. Said rods—especially in the number of two—are mounted in a mobile manner on the cage facing each other, around a respective pivot axis parallel to the general axis of the supports. Said rods can be maneuvered from the release position to the hold-down position so as tojointly exert an antagonistic thrust force at the periphery of the supports to lock them in hold-down position.

Finally, based on the relative position of the manipulator of the third type in relation to the orientation of the second and third windows of the cage prior to turning it over, an additional subsidiary step of the second operation is planned which consists of pivoting the cage around an axis coaxial to the general axis of the supports prior to turning it over.

A third major operation of the method under the invention, upon completion of the prior operation, thus consists of running through the container, from the second window to beyond the one opposite to it, a device to grip individually and move in packs the supports out of and beyond the container. Therefore, with a simple and rapid movement of the unloading device, the supports that said device grasps are led in the same motion to the unloading station.

It is to be noted that to make this operation easier, the movement of the unloading device running through the container shall be an upward movement so as to take and remove the supports out of the container just by supporting them.

Under a favorable embodiment of such unloading device, i.e., with regard to the upward movement of said device, the unloading device is primarily made of a telescopic or similar mast, that supports at its top a cradle designed to receive the supports. Said cradle shall be provided with several individual gripping devices in braced juxtaposition of the supports placed and arranged to match those of the cage.

### BRIEF DESCRIPTION OF THE SEVERAL VIEWS OF THE DRAWINGS

This invention will be better understood and details pertaining thereto will become apparent in the description to be made of a preferred embodiment, based on the figures in the attached plates, in which

FIG. 1 is an overall schematic view of a transfer station equipped with manipulators according to the preferred embodiments of the invention.

FIG. 2 is a synoptic view consisting of the successive diagrams a, b, c, d, e, f, g that illustrate the method under the invention according to a preferred execution process.

FIG. 3 is a perspective view of a transfer manipulator with turning-over motion under a preferred embodiment of the second manipulator proposed by the invention, equipped with means to hold down the supports while they are turned over.

FIG. 4 and FIG. 5 are drawings showing respectively a top view and front view of the cage that is part of the manipulator shown on the previous figure.

### DETAILED DESCRIPTION OF THE INVENTION

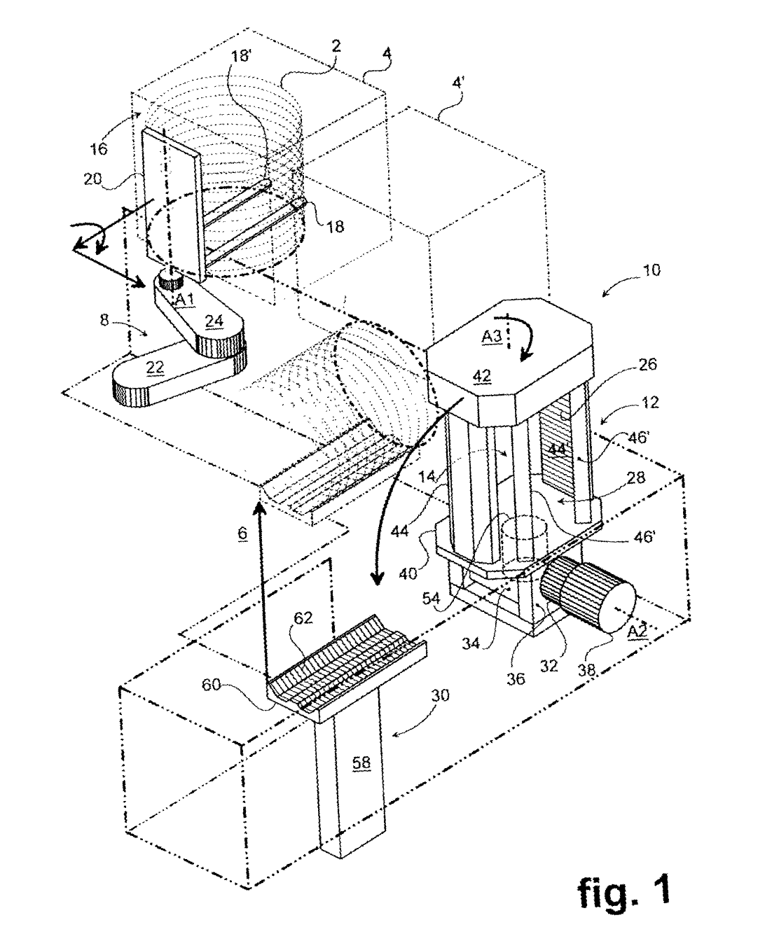

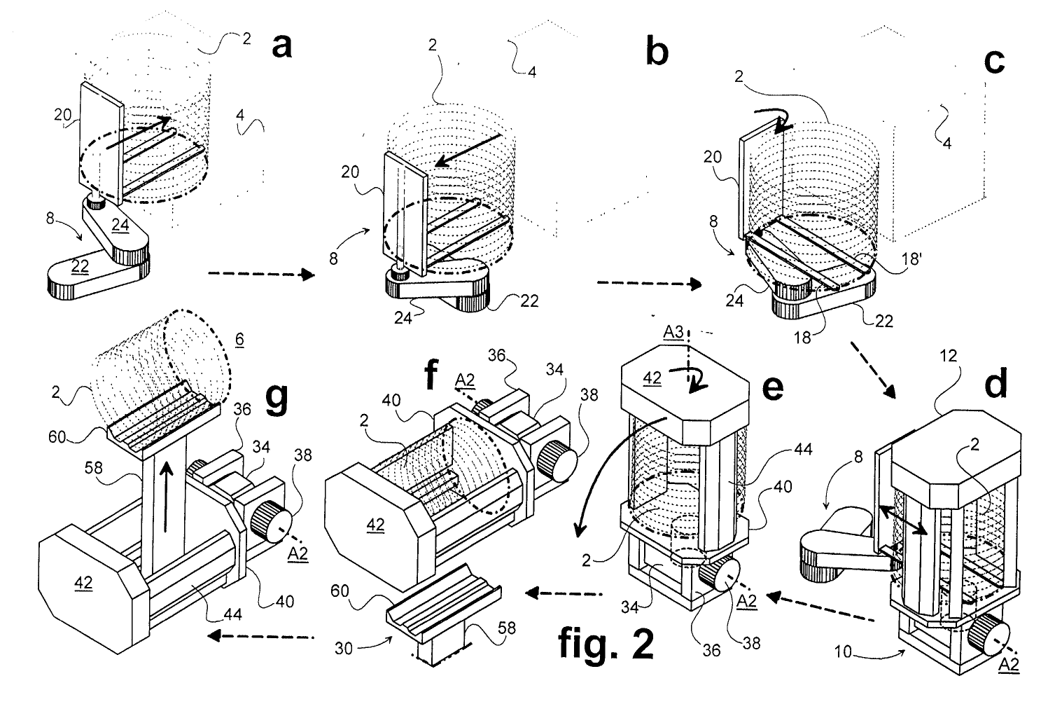

On FIG. 1 and FIG. 2, the purpose of the invention is a method to transfer supports 2 of computer supports in the form of disks between two processing stations.

Such transfer is achieved from at least one basket 4, 4′ of a supply station that contains the supports 2 in tiered superposition and that is located at the exit of an unloading station 6 located at the entrance of another processing unit.

In a first major operation of the method proposed by the invention, the supports 2 are grasped (FIG. 2a) and removed (FIG. 2b) from the supply basket 4 in tiered superposition. These steps of the first major operation under the invention are carried out using a first manipulator 8 to transfer the supports 2 through planar displacement. This operation then consists of another step to move said manipulator 8 (FIG. 2c) up to a second manipulator 10 that transfers the supports 2 by turning them over. In a last step, the supports 2 are then placed (FIG. 2d) in tiered superposition inside a cage 12 of the second manipulator 10 that has at least one window 14 to insert the supports 2.

The first major operation that consists of transferring the supports 2 with the first manipulator 8 advantageously includes an additional step consisting of pivoting in packs (FIG. 2c) the supports 2 in their general plane. The purpose of this operation is to bring the supports 2 opposite to the insertion window 14 in cage 12, that has a transverse orientation in relation to the similar window 16 in supply basket 4. These arrangements, as explained above, permit to improve the transfer rates and to have several adjacent supply baskets 4 used alternatively.

A manipulator 8 designed to transfer the supports 2 in tiered superposition through planar displacement and in packs is advantageously used to carry out this first operation. This manipulator 8 commonly has devices 18, 18′ to grip individually the supports 2, that are supported by a column 20 at its front face. Said individual gripping devices 18, 18′ are for example made of arms arranged in tiered superposition on the column, while being braced in a manner matching the bracing of the supports 2 inside the supply basket 4.

Each arm is especially made of a pair of branches 18 and 18′, accessorily equipped with specific means for individual gripping of the supports (not shown in the Figures). It is understood that only one arm 18, 18′ is represented in the diagrams showing the first manipulator 8 so as to make it easier to understand, but that said arms are several to match the potential number of supports to be transferred.

The column 20 is itself supported by planar maneuvering means 22 and 24 along at least two directions of a plane. The Figures show that these maneuvering means are judiciously designed as tiered arms 22, 24, successively hinged to each other.

In addition, the column 20 is preferably supported by the tiered arms 22, 24 so that it can turn at its rear face and on itself around a pivot axis A1 so as to be able to be pivoted along the general plane of the supports 2. These arrangements are designed to place said supports 2 facing window 14 to insert the supports 2 inside the cage 12 of the second manipulator 10.

Under arrangements not represented in the Figures, the step to remove the supports 2 from the supply basket 4 includes a low amplitude vertical movement of the gripping devices 18, 18′ along column 20.

In a second major operation of the method under the invention, the cage 12 is turned over by tipping it (FIG. 2e and FIG. 2d) around a pivot axis A2 materialized at its base, through which it is supported. The supports 2 are thus turned over in packs between planar orientations, respectively an initial orientation P1 and an unloading orientation P2 that are concurrent.

A manipulator 10 to transfer the supports 2 by turning them over along two concurrent planes P1 and P2 is advantageously used to carry out this second operation. This manipulator 10 commonly has a container 12 to receive and transfer by turning them over the supports 2 and is equipped with devices 26 to grip said supports in tiered superposition.

In addition, the container 12 is provided with a window 14 to access its inside volume in order to insert and remove supports 2. Finally, this container 12 features maneuvering means to turn it over.

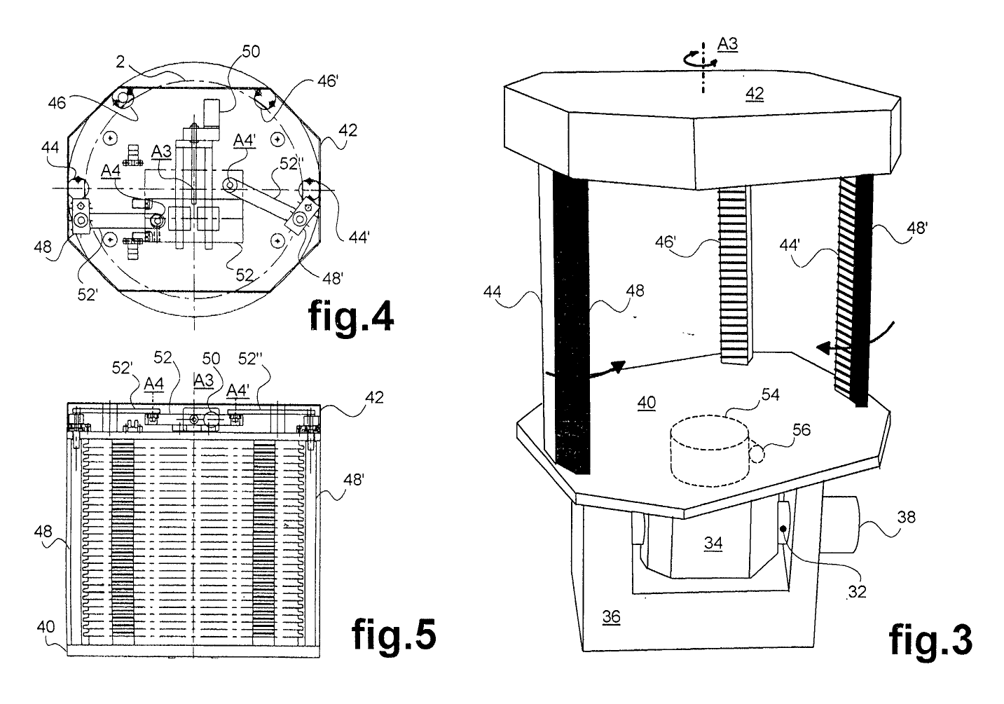

Referring to FIG. 3 and based on an important aspect of this invention, this container 12 is given the form of a cage. It has a second window 28 associated with another opposite window (14) to run through cage 12 an unloading device 30 of supports 2 beyond said cage. In the example shown in the figures, the opposite window consists of the first window 14 to insert the supports 2 inside the cage 12.

In the example shown, the pivot axis A1 of cage 12 is materialized by a spindle 32 connected to cage 12 through a base 34 that receives said cage transversally. This spindle 32 rotates between bearings of frame 36 of the second manipulator. This frame 36 laterally supports the driving means 38 to pivot spindle 32 so as to tip the cage 12.

Still based on the shown example, the cage 12 is made from two plates 40 and 42 separated at a distance by uprights 44, 44′ and 46, 46′ roughly delimiting between them the space receiving the supports 2. The support gripping devices 26 are evenly spread along two lateral uprights, such as 44, 44′, or preferably along all uprights. These gripping devices 26 are for example made of notches or equivalent to respectively receive the supports 2.

It is to be noted on the shown cage 12 embodiment that the second window 28 to run the unloading device 30 of the third manipulator so delimited between these two uprights that are opposite 46 and 46′ to the support 2 insertion window 14.

The second major operation of the method under the invention includes preferably the support 2 hold-down and release steps respectively before and after the cage 12 turn-over step.

To that effect and with reference to FIGS. 3 and 5, the second manipulator 10 is preferably equipped with means to hold down the inserted supports 2 while they are transferred by being turned over. On the embodiment shown, said hold-down means include rods 48, 48′ locking the supports 2 that are mobile between two respective positions of release and hold-down of supports 2, around a respective pivot axis A4 parallel to the general axis A3 of the supports 2. The mobility of the rods 48 is such that they exert toward each other an antagonistic thrust force at the periphery of the supports 2 to hold them tight. The maneuvering means of said rods 48, 48′ are housed inside the upper plate 42 of the cage 12 inside which they are confined. These maneuvering means include a drive device 50 to make the rods pivot trough a set of connecting links 52, 52′, 52″. It should be understood on FIG. 4 that the rods 48, 48′ are represented respectively in support 2 release position for one 48, and in hold-down position for the other 48′, but in fact their maneuvering is concomitant.

On the example shown and referring back to FIG. 1 and FIG. 2, the unloading device 30 of the third manipulator is oriented transversally in relation to the initial orientation of the opposite windows (14, 28) contained in the cage (12). In this case, the second operation to transfer the supports (2) by turning them over includes the step consisting of pivoting the cage (12) around an axis (A3) coaxial to the general axis of the supports (2).

The purpose of these arrangements is to place the windows 14 and 28 of cage 12 and more specifically the passageway made through said cage 12 facing the unloading device 30. To that effect and according to the embodiment shown, the cage 12 is connected to the base 34 through a second pivot pin 54 coaxial to the general axis A3 of supports 2. This pivot pin 54 rotates on base 34 and is maneuvered from drive means 56 arranged according to various options, either and preferably inside the base 34 itself (FIG. 3), or on the frame 36 while being connected to the second pivot pin 54 through transmission means.

A third major operation of the method under the invention consists of grasping the supports 2 in braced juxtaposition inside the cage 12 after turning it over. The supports 2 are taken out of the cage 12 (FIG. 2g) through a continuous grasping movement, taking them beyond the cage 12 and up to the unloading station 6. This grasping and removal are done using the unloading device 30 of a third manipulator that runs inside a corridor provided through cage 12 between the two opposite windows 14 and 18 in said cage 12.

On the example shown, this unloading device 30 is primarily made of a telescopic mast 58 with a cradle 60 at its top. This cradle 60 has several gripping devices 62, more specifically notches, that are evenly spread and braced to match the arrangement of the gripping devices 26 of cage 12.

I claim:

1. Apparatus to transfer the supports (2) of electronic and/or computer supports in the form of disks from at least one basket (4,4′) of a supply station that contains the supports (2) in tiered superposition and is located at the exit of a first processing station, to an unloading station (6) that is located at the entrance of another processing station, characterized:
In that it includes:
A first manipulator (8) to transfer the supports with planar displacement, to grasp and remove from the supply basket (4) the supports (2) in tiered superposition and to lead them to a second manipulator (10) transferring the supports (2) by turning them over in which said supports (2) are placed in tiered superposition inside a cage (12) that has at least one window (14) to insert the supports (2)
The second manipulator (10) designed to turn over the cage (12) by tipping around a pivot axis (A2) materialized (32) at tits base and through which it is supported so as to turn over the supports in packs between two respective initial and release planar orientations that are concurrent.
A third manipulator featuring an unloading device (30) to grasp the supports (2) in braced juxtaposition and take them out of the cage (12) to the unloading station while the unloading device (30) runs through a passageway provided through the cage (12) between two opposite windows (14, 28) contained in said cage (12).

2. Apparatus according to claim 1, characterized:
In that the first manipulator (8) includes means to pivot in packs the supports (2) in their general plane and to bring them facing the insertion window (14) of cage (12) that is oriented transversally to the equivalent window (16) of the supply basket (4).

3. Apparatus according one of the above claims characterized:
In that the second manipulator (10) has means to hold down and release the supports (2) before and after the cage (12) turn-over step respectively.

4. Apparatus according to any one of the above claims characterized:
In that, with the unloading device (30) of the third manipulator oriented transversally in relation to the initial orientation of the opposite windows (14, 28) contained in the cage (12), the second manipulator (10) has means to pivot the cage (12) around an axis (A3) coaxial to the general axis of the supports (2), with the passageway provided through the cage (12) placed opposite thereto to the unloading device (30).

5. Manipulator (8) to transfer the supports (2) in tiered superposition through planar displacement and in packs, that is part of an apparatus according to any one of the above claims, said manipulator (8) having devices (18, 18′) to individually grasp the supports (2) that are supported by a column (20) at its front face that is itself supported by means for its planar maneuvering along the two directions of one plane at least, characterized:
In that the column (20) maneuvering means are designed as tiered arms (22, 24) successively hinged to one another.

6. Manipulator according to claim 5, characterized:
In that the column (20) is supported by the tiered arms (22, 24) so that it rotates on itself to be able to be pivoted along the general plane of the supports (2).

7. Manipulator (10) to transfer the supports (2) by turning them over along two concurrent planes, that is part of an apparatus according to any one of claims 1 through 4, this manipulator (10) having a container (12) to receive and transfer the supports (2) by turning them over, that is equipped with gripping devices (26) to grasp the supports in tiered superposition and provided with a window (14) to access its inside volume to insert at least, and otherwise also remove, the supports (2) and with maneuvering means to turn over this container (12), characterized:
In that the container (12) is designed as a cage with a second window (28) associated with another opposite window (14) to run through the cage (12) a device unloading the supports (2) beyond said cage (12).

8. Manipulator according to claim 7, characterized:
In that it is equipped with means (48, 48′, 52, 52′) to hold down the supports (2) inserted, that include devices (48) locking the supports (2) that are mobile between two respective support (2) release and hold-down positions.

9. Manipulator according to claim 8, characterized:
In that the locking devices are each designed as rods (48, 48′) provided with devices (26) for individual gripping of the supports (2), that are mobile (50, 52, 52′) on the cage (12) facing each other around a respective pivot axis (A4, A4′) parallel to the general axis (A3) of the supports (2), with these rods (48, 48′) being maneuverable (50, 52, 52′) so as to exert jointly at the periphery of all supports (2) an antagonistic thrust force to keep them in hold-down position.

10. Manipulator part of an apparatus according to any one of claims 1 through 4, characterized:
In that it includes an unloading device (30) made of a telescopic mast (58) with a cradle (60) at its top to grip the supports (2) in braced juxtaposition.
